(19) United States
(12) Patent Application Publication
(10) Pub. No.: US 2018/0331781 A1
(43) Pub. Date: Nov. 15, 2018

(54) METHODS AND ARRANGEMENTS FOR PERFORMING ENHANCED NETWORK CODING

(71) Applicant: Telefonaktiebolaget LM Ericsson (publ), Stockhoim (SE)

(72) Inventors: Annikki WELIN, SOLNA (SE); Victor JOHANSSON, SOLNA (SE); Tomas THYNI, JÄRFÄLLA (SE)

(21) Appl. No.: 15/777,200

(22) PCT Filed: Dec. 2, 2015
(86) PCT No.: PCT/SE2015/051300

§ 371 Date: May 17, 2018

(51) Int. Cl. H04L 1/00; H04L 12/26; H04L 29/06

(52) U.S. Cl. CPC H04L 1/0009; H04L 69/16; H04L 43/0888

(57) ABSTRACT

A data block is acquired, the data block is encoded, and the encoded data block is sent addressed to a network receiving node. Feedback information is received from the network receiving node regarding decoding performance of the sent encoded data block, and based on the feedback information, it is determined whether the sent data block was successfully decoded by the network receiving node. When it is determined that the sent data block was not successfully decoded, an adjusted coding parameter value of the coding parameter is determined, the data block is encoded with the adjusted coding parameter value, and the adjusted encoding parameter value data block is sent addressed to the network receiving node. When it is determined that the sent data block was successfully decoded, a subsequent data block is encoded, and the encoded subsequent data block is sent addressed to the network receiving node.

### TECHNICAL FIELD

This disclosure relates generally to transport of data in communication networks. Particularly, it relates to methods and arrangements related to Network Coding in communication networks.

### BACKGROUND

In packet switched (PS) communication networks, data packets are distributed between communication network nodes, e.g. routers, switches, bridges, etc. TCP/IP

(Transmission Control Protocol/Internet Protocol) is a protocol which is commonly used in the communication networks for controlling the packet distribution within the communication networks. When communicating data in accordance with TCP/IP, the data packets sent from one communication network node are acknowledged when received by another communication network node, and in case that a data packet is not acknowledged to be received, this data packet is retransmitted. Therewith an appropriate communication may be achieved. However, for communication links which are disturbed or congested, a substantial amount of data packets may have to be retransmitted before being securely conveyed.

Another technology for according to which data packets may be conveyed is based on so called Network Coding.

Network coding was introduced as an idea of a single node in a communication network combining incoming packets using linear combinations of these packets. One of the benefits of combining packets by their linear combinations is that you may send several independent packets over the same transmission link, with the same size as only one packet. This method may reduce the amount of data sent over network links, hence reducing the risk of congestion over a network node. However, when a combined packet arrives at the receiver, i.e. a communication receiving node, e.g. a client, the receiver needs to have information about some of the other independent packets in the combination in order to extract the desired packet.

This idea was further evolved into developing network coding schemes to correct packet error bursts over a single transmission. Instead of having specific data in each packet, packets containing overall information about the whole file is transmitted. As long as the receiver receives enough overall information about the file, i.e. so called overshoot information, it can find out the original data by using the information acquired. The combining of several packets will be referred to as encoding the packets, while extracting a packet will be referred to as decoding a packet.

The receiver starts by initializing a decoder by using the same parameters as the sender, i.e. a communication network sending node, e.g. a client, used when it initialized its encoder. The receiver reads the block number of each coded packet, which is sent as the first bytes of the coded packet. This information is required for the receiver to know when a new block is received. If the decoding is completed before a new block arrives, then the receiver simply waits until it reads the block number of a new block.

With reference to FIG. 1, which is a schematic diagram, a principle of controlling PS distribution of data by applying Network Coding will now be exemplified.

In the communication network five communication network nodes 1, 2, 3, 4, 5 are illustrated. Two data blocks A, B are also illustrated. The data packet A is received with a data packet by the communication network node 1, and the data block B is received with another data packet by the communication network node 2. The communication network node 1 forwards the data packet comprising the data block A to the communication network node 3, but also to the communication network node 5. Similarly, the communication network node 2 forwards the other data packet with the data block B to the communication network node 3, but also to the communication network node 6. When the communication network node 3 has received the data packets that comprises the respective data blocks A and B, it processes the data blocks A and B into one or more combined data packets that respectively comprise parts of the data blocks A and B (combined data packets are illustrated as “A+B”). The processing of the data packets is also known as encoding. The communication network node 4 receives the combined data packets A+B and forwards them to both the communication network nodes 5 and 6. The communication network nodes 5 and 6 will then be enabled to decode the encoded combined data packets into the data blocks A and B, i.e. extracting the original data blocks. When implementing Network Coding solutions, so called overshoot information is sent, which the sending communication network node utilises for encoding the data blocks, and, consequently, the receiving network node utilises for decoding the data blocks.

With reference to FIG. 2, which is a schematic overview, a situation in a Network Coding controlled communication network will now be described, in accordance with one example.

In the communication network a network sending node 100 is arranged to send data to a network receiving node 120. The data is distributed as data packets via a transport links and transport nodes (e.g. routers) 110. The data packets may propagate along different paths extending from the network sending node and the network receiving node 120. In the figure two examples of paths are illustrated (Path A and Path B). Even if the figure only refers to two different paths, further possible path could be established in the transport network. In order to ensure that the data is securely distributed from the transport sending node 100 to the transport receiving node 120, and could be successfully decoded at the transport sending node 120, as well combined data packets, i.e. packets comprising encoded combinations of parts of data blocks (A+B in FIG. 1), and non-combined data packets, i.e. packets comprising encoded parts of single data blocks (A or B in FIG. 1).

However, in order to meet future demands for increased transmission rates of data there is a challenge to more efficiently make use of installed communication resources in Network Coding controlled communication networks.

### SUMMARY

It would be desirable to obtain improved performance in communication networks. It is an object of this disclosure to address at least any of the issues outlined above.

Further, it is an object to provide a method for optimizing throughput in Network Coding based communication networks. These objects may be met by a method and an arrangement according to the attached independent claims.

According to one aspect, a method is provided which is performed by a network coding module for controlling encoding of data to be sent from a network sending node of a communication network applying Network Coding. The method comprises acquiring a data block to be addressed to a network receiving node, e.g. a client, encoding the data block in accordance with a coding parameter such as overshoot ratio, and sending the encoded data block addressed to a network receiving node. Furthermore, the method comprises receiving feedback information from the network receiving node regarding decoding performance of the sent encoded data block, and based on the feedback information, determining whether the sent data block was successfully decoded by the network receiving node or not. Moreover, the method comprises, when it is determined that the sent data block was not successfully decoded, determining an adjusted coding parameter value of the coding parameter, encoding the data block with the adjusted coding parameter value, and sending the with the adjusted coding parameter value encoded data block addressed to the network receiving node, and, when it is determined that the sent data block was successfully decoded, encoding a subsequent data block, in accordance with the coding parameter value and sending the encoded subsequent data block addressed to the network receiving node.

Furthermore, within the method, receiving the feedback information may comprise receiving a notification that the data block was successfully decoded by the network receiving node. Determining the adjusted coding parameter value may comprise determining an increased overshoot value, and the method may further comprise determining whether the subsequent data block will be encoded with a decreased overshoot value or not, and when it is determined that the subsequent data block may be encoded with a decreased overshoot value determining the decreased overshoot value.

According to a another aspect, a method is provided which is performed by a network decoding module for controlling decoding of data received by a network receiving node, e.g. a client, of a communication network applying Network Coding. The method comprises receiving an encoded data block, i.e. a symbol, originating from a network sending node, initiating decoding of the received encoded data block, and determining decoding performance of the received data block. Furthermore, the method comprises compiling feedback information related to the decoding performance, and sending the feedback information to the network sending node.

Moreover, the method may further comprise extracting a block number of the decoded block, determining whether extracted block number differs from the block number of a previously decoded or received block and compiling the feedback information further related to a determined difference between the block numbers.

Furthermore, the method may additionally or alternatively also comprise obtaining at least one transport network performance parameter value from a network control node, such as a Radio Resource Management (RRM) node or a Performance Monitor (PM) node, wherein compiling the feedback information may be further related to the obtained at least one network parameter. Obtaining the at least one network performance parameter value, may comprise determining at least one of: a link status value, a network delay value, a transport capacity value, a transport resource quality value, a packet loss value, and a congestion status value.

According to a further aspect, a network coding module which is configured to be arranged in a network sending node, and a network decoding module which is configured to be arranged in a network receiving node are also provided. The network coding module and the network decoding module are respectively adapted to perform any of the above described methods.

By implementing the above described methods and modules, a network receiving node may be enabled to receive feedback regarding successfulness in decoding of transmitted data, while receiving subsequent data. Thereby, reliability of data transmission may be improved without delaying the ongoing data transmission.

By determining decoding performance at the network decoding module and provide to the network coding module, the network coding module may be enabled to optimize coding parameters to the actual situation in the communication network. Thereby, overshoot transmission of data may be decreased which may reduce congestion and increase throughput of data in communication networks.

### BRIEF DESCRIPTION OF DRAWINGS

The solution will now be described in more detail by means of exemplary embodiments and with reference to the accompanying drawings, in which:

FIG. 1 is a schematic illustration of a situation in accordance with the existing art.

FIG. 2 is a schematic illustration of a situation, according to possible embodiments.

FIG. 3 is a schematic flow chart of a method, according to a possible embodiment.

FIG. 4 is a schematic flow chart of a method, according to a possible embodiment.

FIG. 5 is a schematic block diagram of a network coding module, according to a possible embodiment.

FIG. 6 is a schematic block diagram of a network decoding module, according to a possible embodiment.

FIG. 7 is a schematic block diagram of a computer program product, according to a possible embodiment.

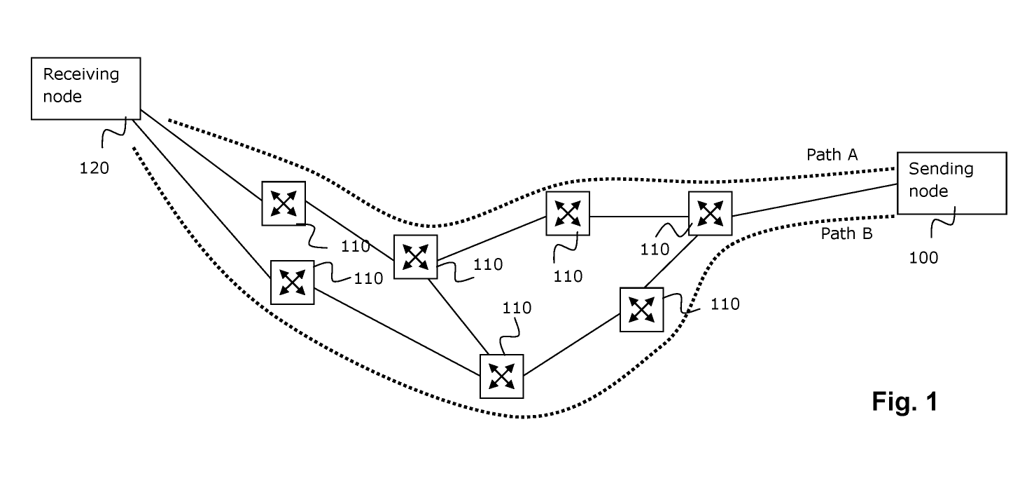

### DETAILED DESCRIPTION

There is a need for a solution which increases throughput of data in Network Coding based communication networks.

By implementing functionality in network receiving nodes for determining decoding performance of data in network receiving nodes, compiling feedback information regarding the decoding performance, and sending the feedback information to a network sending node, the network sending node may be enabled to adjust a so called overshoot parameter based on the feedback information when coding further data blocks.

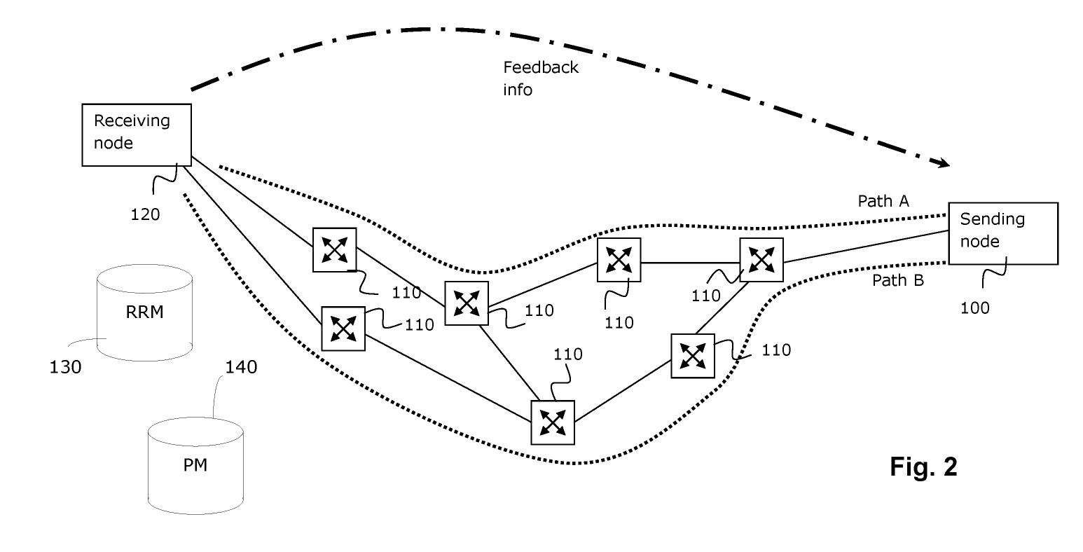

The communication network of this embodiment is based on the communication network described in conjunction with FIG. 2, but differs in that feedback information is provided from the network receiving 120 node to the network sending node 100. The feedback information is related to the decoding performance of received data blocks. However, the feedback information may further also be related to network performance parameters. For instance, as will be further disclosed information, when compiling the feedback information, the network receiving node 120 may obtain information regarding congestion status, link load, buffer statuses, various delays, etc. from suitable communication network control nodes, i.e. RRM (Radio Resource Management) nodes 130, or PM (Performance Monitor) nodes 120.

The feedback information may be received by the network sending node 100 formulated as any suitable data message or signal. In the exemplifying embodiments of this disclosure, the network nodes 100, 110, 120 are described such that data packets are sent in one single direction from the network sending node via intermediate network nodes to a network receiving node 120, in order to facilitate the understanding.

However, when put into practice, the disclosed concept is not limited thereto. Typically, communication scenarios are complex and data packets may be conveyed in two directions, such that the network sending node 100 and the network receiving node 120 simultaneously both may send and receive data packets from each other, i.e. the network sending node 100 may act also as network receiving node 120, and vice versa.

For instance, feedback information compiled by the network receiving node 120 may be sent to the network sending node 100 as data packets encoded by the network receiving node 120. In addition, even if the illustrated communication network only comprises one network sending node 100 and one network receiving node 120, the communication network may comprise a suitable plurality of network sending/receiving nodes 100/120, without limitation.

Principles of Coding in RNLC (Random Linear Network Coding)

With reference to the equations 1, 2, 3 and 4 some general principles of coding in RNLC will now be described, according to an example of existing art. This example relates both to encoding of data and to decoding of data.

When applying RNLC based transmission of data, an amount of data to be transmitted is splitted into a plurality of data blocks M. A data block M may also be referred to as a generation of size g, and comprise g symbols (i.e. vectors). The structure of a data block M is defined below by the equation 1.

M=[\vec{m}₁;\vec{m}₂; . . . ; \vec{m}_{g}], where \vec{m}ᵢ is a vector
Equation 1: The matrix of the generation size g number of symbols. The symbols are expressed as vectors of data in the finite field.

RLNC Encoding

An encoded symbol in RLNC consists of a random linear combination of all the symbols in a generation (i.e. a block M). The encoded symbol is computed by applying linear algebra to multiply the generation matrix M with a randomly chosen coding vector \vec{v}. The coding vector \vec{v} consists of the generation size number g of coefficients, with each coefficient representing a symbol in the generation. The encoded symbol is computed by multiplying the generation matrix with the generated coding vector, as seen in Equation 2.

\vec{x}=M×\vec{v}, where \vec{v}={v₀, v₁, . . . , v_{g-1}}
Equation 2: The computation of an encoded symbol between the generation matrix and the coding vector.

The equation results in a vector of the same size a symbol \vec{m}ᵢ, but represents a combination of all the vectors in the generation. The encoded symbol \vec{x} the coding vector \vec{v} needs to be known to the receiver, to be able to decode the block M of data. A coded data packet, consisting of the encoded symbol \vec{x}, and the coding vector \vec{v}, is sent to the receiver, i.e. the network receiving node.

RLNC Decoding

The receiver of the transmission gathers coded packets until a generation can be decoded. The vectors of a coded packet (\vec{x},\vec{v}) are stored in two different matrixes \vec{V}, see Equation 3.

(\vec{x}, \vec{v})→\vec{X}=[\vec{x}₁,\vec{x}₂, . . . , \vec{x}_{g}], \vec{V}=[\vec{v}₁, \vec{v}₂, . . . , \vec{v}_{g}]
Equation 3: The vectors of a coded packet are stored in two separate matrices.

The decoding is done by solving a linear equation system by applying linear algebra, as defined by Equation 4 below. By acquiring enough encoded symbols \vec{x} and information about the encodings \vec{v}, i.e. dimensioning g large enough, one can find the generation matrix M, i.e. the data block M.

\vec{X}=M*\vec{V}→\vec{X}*\vec{V}⁻¹=M
Equation 4: By applying linear algebra to solve the equation system, the receiver can acquire the generation matrix M.

One of the problems with RLNC is that it's dependent on UDP (User Datagram Protocol), which doesn't support congestion control. RLNC based implementations needs to support some form of congestion control, but no one has yet found an efficient way of doing so.

The problem of using network coding with TCP is caused by the receiver of a packet cannot send an ACK to the sender before the receiver has been able to decode it. Furthermore, this decoding cannot be done instantaneously when the packet arrives, as decoding can only be done when the receiver has received sufficient evidence to extract the correct contents of the encoded packet. This problem can cause delays in the different TCP connections passing through the network.

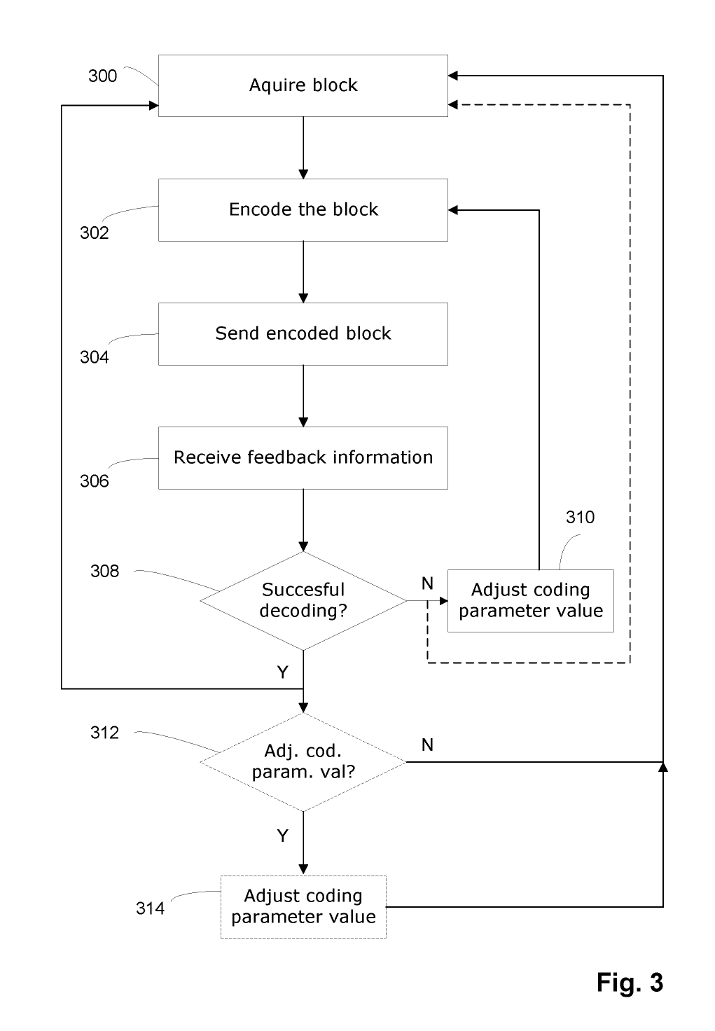

With reference to FIG. 3, which is a schematic flow chart, a method performed by a network coding module will now be described in accordance with one exemplifying embodiment.

The network coding module is configured to be arranged in a network sending node, i.e. a network node which is adapted to send packet data and applies Network Coding.

The network sending node may be adapted to be arranged in both wireless and wireline networks. The method actions of this exemplifying embodiment will be defined for the case that the network sending node, e.g. a server, and a network receiving node, e.g. a client, have been communicatively connected to each other for exchanging data.

In an action 300, the network coding module acquires a data block M to be addressed to a network receiving node. The data block M may be acquired by splitting up a data packet to be sent in a plurality of data blocks, where the data block M is one data block of the plurality of data blocks. The data block M may comprise g symbols, where each of the symbols is represented as a respective vector of data.

In a following action 302, the data block M is encoded in accordance with a coding parameter. In this embodiment, the coding parameter is a coding vector comprising g coding vector values v₀, v₁, v₂, . . . , v_{g-1}, i.e. the coding vector v has the length g. The coding results in an encoded symbol \vec{x}. In practice, some of the encoded symbols may be lost or received corrupted at the network receiving node, and therefore an overshoot of encoded symbols may be calculated when encoding the data block M. By performing the encoding such that it results in a total amount of encoded symbols which exceeds g and dimensioning the overshoot carefully, for a total amount of “g+overshoot”, g encoded symbols may arrive correct to the network receiving node. Because all encoded symbols are related to the encoded data block M, the data block M may be appropriately decoded. Each respective encoded symbol may be the result of a multiplication with a respective coding vector of length g.

In a subsequent action 304, the encoded data block is sent addressed to the network receiving node. The encoded symbols may be sent together with the respective coding vectors. When the encoded data block is sent an amount of “g+overshoot” data packets that each comprises one encoded symbol and a corresponding respective coding vector of encoded symbols may be sent.

In response to the sent encoded data block, i.e. the “g+overshoot” data packets, in a following action 306, the network coding module receives feedback information regarding decoding performance of the encoded data block at the network receiving node. The feedback information regarding decoding performance is in this embodiment received formulated as a data message in accordance with UDP (User Datagram Protocol), without being limited thereto. However, the feedback information may be alternatively formulated within the disclosed concept, e.g. as any suitable data message according to any alternative transport protocol, such as TCP (Transmission Control Protocol), etc. Alternatively, the feedback information may be sent based on Network Coding. In that case the network receiving node will act as sender of the feedback information and the network sending node will act as receiver of the feedback information, i.e. the roles of the nodes will be switched when providing the feedback information.

In an action 308, according to the received feedback information the network coding module determines whether the sent encoded symbol was successfully decoded (Y in FIG. 3) or not (N in FIG. 3) by the transport receiving node.

In another action 310, which is performed when it in action 308 was determined that the decoding was not successful (N in FIG. 3), the network coding module determines an updated coding parameter value and adjusts the current coding parameter value to the updated coding parameter value. In this embodiment the coding parameter value relates to overshoot and the adjusted coding parameter value is determined as an increased overshoot value, which is applied when the method proceeds with repeating the action 302 of encoding the current data block, i.e. an increased amount “g+increased overshoot” of encoded symbols are calculated, before being sent together with their respective coding vectors in the action 304, etc.

This may give rise to that the network receiving node may decode the encoded data block successfully, even if some encoded data packets are lost during the transmission. Because the network receiving node may receive enough encoded data packets to process and decode the encoded data block successfully, the result of the determination 308 will be positive and the method may proceed by acquiring a subsequent data block.

It is to be noted that the repetition of the action 302 does not have to be performed directly when it has been determined that the decoding was not successful. The determination of an updated parameter value, e.g. determining that further encoded symbols will be calculated for further respective further coding vectors, may alternatively be performed after a subsequent data block(s) have been encoded and sent. Thereby, an ongoing sending of data may be prevented from being interrupted or delayed, but the data of the current data block may still be properly transported to the network receiving node. For instance, when a received data block could not be successfully decoded, e.g. due to that it was disturbed by congestion, delay, packet loss, etc., transmission of encoded subsequent data blocks may be performed without substantial delay. Thereby, a non-blocking feedback mechanism may be provided in accordance with RNLC. When it instead was determined in action 308 that the sent encoded symbol was successfully decoded, the action 300 is repeated for a subsequent data block, i.e. a further data block is acquired.

However, increasing the overshoot gives rise to increased amount of data to be sent. In addition, to large encoded symbols may further lead to that encoded blocks will be larger than an MTU (Maximum Transmission Unit), which give rise to that fragmentation of encoded symbols may occur, which increases packet loss in transmission. Therefore, there is challenge to optimize and balance the overshoot.

In a related exemplifying embodiment, which is based on the above described embodiment, in case that it was determined in the action 308 that the decoding was not successful (N in FIG. 3) but the overshoot could not be further increased, e.g. an overshoot threshold should be exceeded by increasing the overshoot further, instead of determining and adjusting the coding parameter value, the action 310 is omitted, and the method proceeds with acquiring a new block in action 300 (illustrated with a dashed arrow).

In another related exemplifying embodiment, which is based on any of the above described ones, in the action 308, the determination indicates that the decoding at the network receiving node was successful (Y in FIG. 3).

In a following action 312, the network coding module determines whether the overshoot will be decreased (Y in FIG. 3) or not (N in FIG. 3). This determination may be performed by analysing statistics of history for adjustments of overshoot, e.g. if the result of determining that the network receiving node could decode an encoded block a specific number of times or during a specific time period, the process may proceed with performing the action 314 and adjust the coding parameter value (i.e. overshoot), and before proceeding with the action 300 for a subsequent block. Else if the determination of the action 312 indicates that no adjustment will take part (N in FIG. 3), the method proceeds with the action 300 without adjusting the coding parameter value.

Thus, by taking history or statistics of performed adjustments of coding parameter values, the network coding module may carefully determine whether the coding parameter value could be adjusted without deteriorating the success rate in decoding or exceeding the MTU for the encoded data blocks. As a further advantage, the total amount of traffic in the communication network may be decreased because overshoot may not have to be over dimensioned in order to achieve a robust communication where encoded blocks could be transmitted and properly decoded at the network receiving node.

In addition, in case that the feedback information received from the network receiving node comprises further information, e.g. regarding congestion status, delays in the communication network, etc., in the action 312, the network coding module may take this further information into account as basis for the determination. Furthermore, it is to be noted that the actions of the above described exemplifying embodiments does not have to be performed in a sequence with one action being performed after another action. Instead, some of the actions may be performed simultaneously. For instance, the network coding module may encode and send subsequent data blocks while waiting for feedback information of a previously encoded and sent data block. When later receiving this feedback information, it may be utilised for adjusting the coding parameter for data block it relates to. Thus, an ongoing transmission may not be interrupted but the reliability of the transmission will still be improved, i.e. a non-blocking feedback mechanism may be provided.

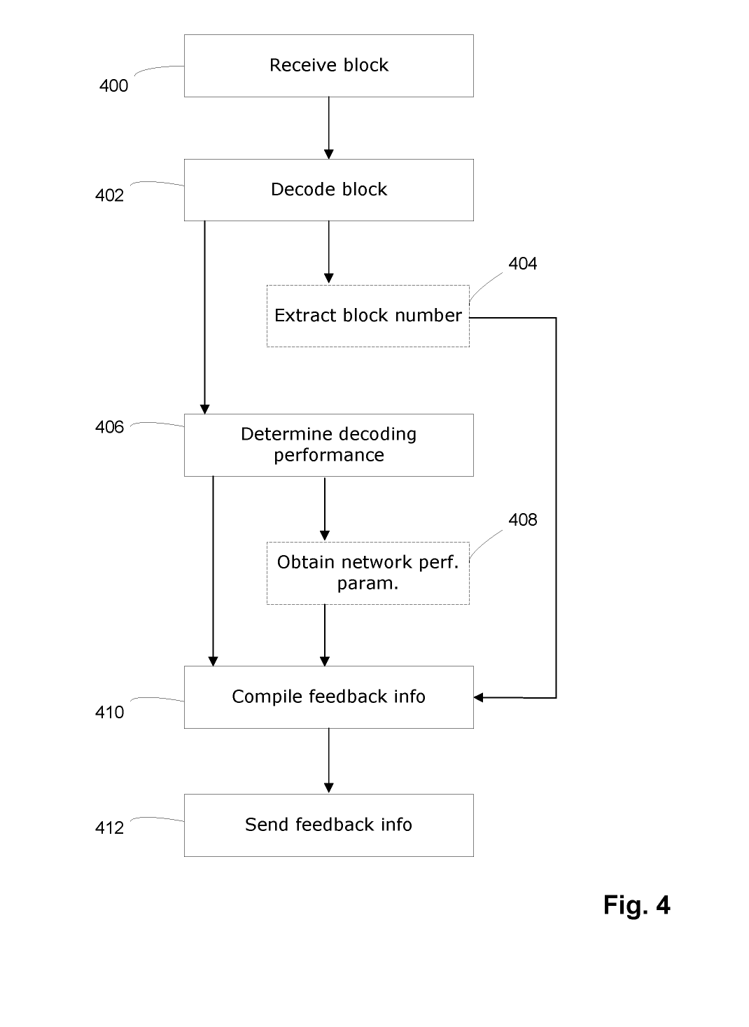

With reference to FIG. 4, which is a schematic flow chart, a method performed by a network decoding module will now be described in accordance with one exemplifying embodiment.

The network decoding module is configured to be arranged in a network receiving node, i.e. a network node which is adapted to receive packet data and applies Network Coding.

The network receiving node may be adapted to be arranged in both wireless and wireline networks. The method actions of this exemplifying embodiment will be defined for the case that the network receiving node, e.g. a client, and a network sending node, e.g. a server, have been communicatively connected to each other for exchanging data.

In an initial action 400, an encoded data block is received by the network decoding module. The encoded data block may be received formulated as a plurality of data packets that each comprises a respective encoded symbol and a corresponding coding vector. It is to be noted that the encoded symbols and their respective coding vectors may vary between the different data packets. However, all data packets comprise parts of the encoded data block, as stated above in another embodiment.

In a subsequent action 402, the network decoding module initiates decoding of the received encoded data block. The decoding may be performed by including the received encoded symbols in a symbol matrix X and the received coding vectors in a coding matrix V. Based on the symbol matrix X and the coding matrix V, the original block M may be calculated in the case that enough encoded data packets, i.e. an amount of g encoded data packets, could be received. As described above in another embodiment, the encoded data packets might be a result of encoding symbols of a data block by multiplying the symbols with respective encoding vectors.

In another action 406, the network decoding module determines a performance of the decoding. Typically, the network decoding module determines if it has received enough data packets, i.e. as many data packets as the coding vector has positions (i.e. length g of the coding vector). In addition, the network decoding module may further base the determination on correctly received data packets only, e.g. discarding data packets which indicate that they have been incorrectly transported. For instance any suitable checksum or control flag of the received data packets may be evaluated when receiving the data packets.

In a following action 410, the network decoding module compiles feedback information regarding the performance of the decoding and, in a final action 412, sends the compiled feedback information addressed to the network sending node. The feedback information may be formulated in various ways, e.g. as an acknowledgement message that indicates that the data block was successfully decoded, or as a more complex instruction message that may instruct the network sending node to increase or decrease overshoot. The feedback may further be sent in accordance with any suitable transport protocol, such as UDP or TCP.

In a related exemplifying embodiment, which is based on the above described one, the network decoding module may extract further information to be utilised as a further basis for the feedback information to be sent to the network sending node.

In an action 404, the block number of the decoded data block is extracted. The block number may be extracted from received data packets comprising encoded symbols and corresponding coding vectors. The extracted block numbers may be utilised as an indication of which data block the encoded symbol relates to. This extracted block number may be utilised as a further basis when compiling the feedback information in the action 410. For instance, the amount of new block numbers during a specific time period of during a specific number of decoding encoded data blocks may make the feedback information more detailed, which may give rise to that more appropriate decisions, e.g. regarding adjustments of overshoot, could be done by the network coding module of the network sending node.

In another related exemplifying embodiment, which is based on any of the above described embodiments, the network decoding module may in addition obtain information regarding network performance of the communication network. For instance, such further information may relate to various delays or congestion in specific links or nodes of the communication network.

In an action 408, the network decoding module obtains information regarding network performance from appropriate control nodes or databases of the communication network. Typically, when the communication network is wireless, the information regarding network performance is obtained from an RRM (Radio Resource Management) node that is arranged in the communication network. However, the disclosed concept is not limited to be performed for wireless networks only, and could also be applied for wireline based communication networks of combinations of wireless and wireline communication networks. For wireline based networks such information regarding network performance may instead be obtained from a PM (Performance Monitor) node arranged in the wireline based communication network. The information regarding network performance may be obtained as at least one network performance parameter value and comprise any of: a link status value, a network delay value, a transport capacity value, a transport resource quality value, a packet loss value, and a congestion status value. However, the disclosed concept is not limited to these network performance parameters, and a skilled person realises that also other suitable network performance parameters and their respective values may be taken into account as an alternative or in combination when appropriate. The network performance parameter values may then be utilised as a further basis, when compiling feedback information in action 410. By taking also network performance parameter values into account when compiling, the feedback information may be further more detailed, which may give rise to that more appropriate decisions, e.g. regarding adjustments of overshoot, could be taken by the network coding module of the network sending node.

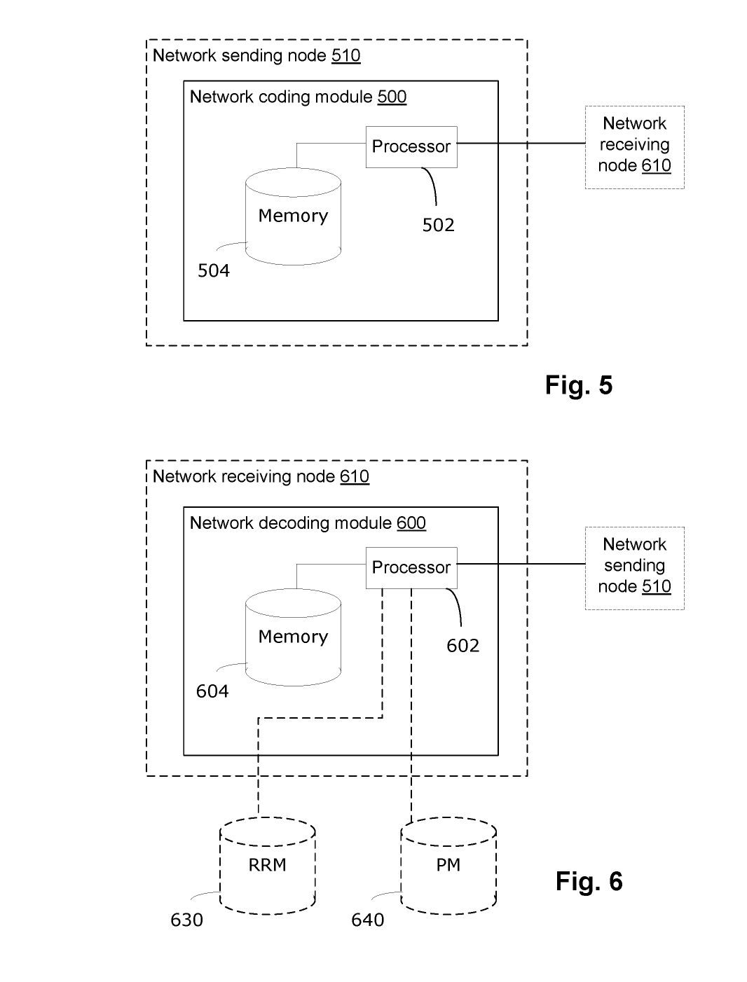

With reference to FIG. 5, which is a schematic block diagram, a network coding module 500 will now be described in accordance with one exemplifying embodiment.

The network coding module 500 is to be arranged in a communication network node that is capable of sending data in a communication network in accordance with Network Coding. In this embodiment the network coding module 500 is arranged in a router 510, which is a communication network node that is capable to be connected to other communication network nodes for sending data.

The network coding module 500 comprises a processor 502 and a memory 504, and optionally further processors and storage units.

The processor 502 is adapted to execute instructions stored in the memory 504, which causes the network coding nodule 500 to acquire a data block to be addressed to a network receiving node 610, such as a client, and encode the data block in accordance with a coding parameter, such as an overshoot ratio. Furthermore, the processor 502 is also adapted to execute instructions that causes the network sending node 510 to send the encoded data block to the network receiving node 610, and receive feedback information in response regarding decoding performance of the sent encoded data block at the network receiving node 610. The processor 502 is further adapted to cause the network coding module 500 to determine, whether the sent data block was successfully decoded by the network receiving node 610 or not based on the feedback information, and if it was determined to be not successfully decoded, determine an adjusted coding parameter value, encoding the data block with the adjusted coding parameter value, and resending the data block addressed to the network receiving node 610. The processor 502 is further adapted to, when it was determined that the data block was successfully decoded, cause the network sending module 500 to encode a subsequent data block in accordance with the coding parameter value and send the encoded subsequent data block addressed to the network receiving node.

With reference to FIG. 6, which is a schematic block diagram, a network decoding module 600 will now be described in accordance with one exemplifying embodiment.

The network decoding module 600 is to be arranged in a communication network node that is capable of receiving data in a communication network in accordance with Network Coding. In this embodiment the network decoding module 600 is arranged in a router 610, which is a communication network node that is capable to be connected to other communication network nodes for receiving data.

The network decoding module 600 comprises a processor 602 and a memory 604, and optionally further processors and storage units.

The processor 602 is adapted to execute instructions stored in the memory 604, which causes the network decoding module 600 to receive an encoded data block originating from a network sending node 510, such as a server, and initiate decoding of the received encoded data block.

Furthermore, the processor 602 is also adapted to execute instructions that causes the network decoding module 600 to determine decoding performance of the received data block, compile feedback information related to the decoding performance, and send feedback information to the network sending node 510.

Moreover, the processor 602 may further cause the network decoding module 600 to obtain transport network parameter value(s) from appropriate network control nodes, such as RRM (Radio Resource Management) nodes 630 or PM (Performance Monitor) nodes 640, and take the obtained transport network parameter value(s) into account when compiling the feedback information. As an alternative, or in addition, the processor 602 may cause the decoding module 600 to extract block numbers from decoded data packets, and take the extracted block numbers into account when compiling the feedback information. An increased block number of a currently decoded data block compared with a previously non-successfully decoded data block is an indication that an overshoot ratio could not be increased by the network coding module 500 of the network sending node 510 and may be valuable input when compiling the feedback information.

Even if the network coding module 500 and network decoding module 600 are described as either having functionality for encoding or decoding, respectively, the inventive concept is not limited thereto. In general, a communication network node, e.g. a router, may communicate data in both directions, i.e. both send and receive data, and communicate data with more than one other communication network node. Therefore, both the functionality of encoding and decoding data blocks may be implemented in one and the same network coding module, when put into practice.

It is to be noted that the network coding module may comprise further components or units arranged to provide ordinary functionality. For instance, both the network coding module 500 and the network decoding module 600 may have specific communication interfaces arranged, respectively (not shown in the FIGS. 5 and 6), via which their respective processors 502/602 communicate with other network nodes, such as routers, or communication network control nodes, such as RRM (Radio Resource Management) nodes, or PM (Performance Monitor) nodes.

It is also to be noted that components and units in the above described embodiments are non-limiting implementation examples, and that their functionality may be alternative implemented, without deviating from the disclosed concept. For instance, instead of a processor and a memory, specific means or units corresponding to the above described actions may be arranged for performing these actions. A data block acquiring means or a data block acquiring unit may acquire the data block to be addressed to the network receiving node, an encoding means or an encoding unit may encode the data block in accordance with the coding parameter, etc.

Similarly, a receiving means or a receiving unit may receive the encoded data block, a decoding means or a decoding unit may initiate decoding of the received encoded data block, a decoding performance determining means or a decoding performance determining unit may determine decoding performance, etc.

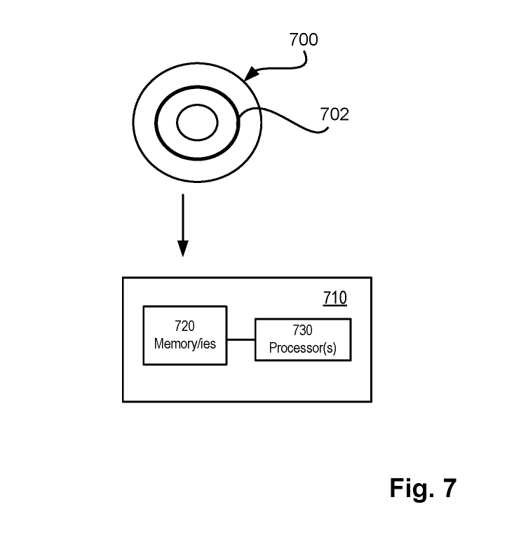

According to some exemplifying embodiments, a computer program product comprises a computer readable medium such as, for example, a diskette or a CD-ROM (Compact Disc Read Only Memory) as illustrated by 700 in FIG. 7. The computer readable medium 700 may have stored thereon a computer program comprising program instructions. The computer program may be loadable into a data-processing unit 730, which may, for example, be comprised in a network coding module or network decoding module 710. When loaded into the data-processing unit 730, the computer program may be stored in a memory 720 associated with or integral to the data-processing unit 730. According to some embodiments, the computer program may, when loaded into and run by the data-processing unit 730, cause the data-processing unit 730 to execute method steps according to, for example, any of the methods shown in the FIG. 3 or 4.

It is to be noted that the arrangements of the described exemplifying embodiments are described in a non-limiting manner Typically, a designer may select to arrange further units and components to provide appropriate operation of the network coding module or network decoding module, within the described concept, e.g. further processors or memories. Moreover, physical implementations of the proposed arrangements may be performed alternatively within the disclosed concept. For instance, functionality of a specific illustrated unit, module, or node may be implemented in another suitable unit, module, or node when put into practice.

The functions of the various elements including functional blocks may be provided through the use of hardware such as circuit hardware and/or hardware capable of executing software in the form of coded instructions stored on the above-mentioned computer readable medium. Thus, such functions and illustrated functional blocks are to be understood as being either hardware-implemented and/or computer-implemented, and thus machine-implemented. In terms of hardware implementation, the functional blocks may include or encompass, without limitation, digital signal processor (DSP) hardware, reduced instruction set processor, hardware (e.g., digital or analogue) circuitry including but not limited to application specific integrated circuit(s) [ASIC], and/or field programmable gate array(s) (FPGA(s)), and (where appropriate) state machines capable of performing such functions. In terms of computer implementation, a computer is generally understood to comprise one or more processors or one or more controllers. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Reference throughout the specification to “one embodiment” or “an embodiment” is used to mean that a particular feature, structure or characteristic described in connection with an embodiment is included in at least one embodiment. Thus, the appearance of the expressions “in one embodiment” or “in an embodiment” in various places throughout the specification are not necessarily referring to the same embodiment. Further, the particular features, structures or characteristics may be combined in any suitable manner in one or several embodiments. Although the present invention has been described above with reference to specific embodiments, it is not intended to be limited to the specific form set forth herein. Rather, the invention is limited only by the accompanying claims and other embodiments than the specific above are equally possible within the scope of the appended claims. Moreover, it should be appreciated that the terms “comprise/comprises” or “include/includes”, as used herein, do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality. Finally, reference signs in the claims are provided merely as a clarifying example and should not be construed as limiting the scope of the claims in any way.

The scope is generally defined by the following independent claims. Exemplifying embodiments are defined by the dependent claims.

1. A method performed by a network coding module for controlling encoding of data sent from a network sending node of a communication network applying Network Coding, the method comprising:
acquiring a data block to be addressed to a network receiving node,
encoding the data block in accordance with a coding parameter,
sending the encoded data block addressed to a network receiving node,
receiving feedback information from the network receiving node regarding decoding performance of the sent encoded data block,
based on the feedback information, determining whether the sent data block was successfully decoded by the network receiving node or not, and
when it is determined that the sent data block was not successfully decoded, determining an adjusted coding parameter value of the coding parameter, encoding the data block with the adjusted coding parameter value, and sending the with the adjusted coding parameter encoded data block addressed to the network receiving node, and
when it is determined that the sent data block was successfully decoded, encoding a subsequent data block, in accordance with the coding parameter value and sending the encoded subsequent data block addressed to the network receiving node.

2. The method according to claim 1, wherein receiving the feedback information comprises receiving a notification that the data block was successfully decoded by the network receiving node.

3. The method according to claim 1, wherein the coding parameter relates to overshooting, and wherein determining the adjusted coding parameter value comprises determining an increased overshoot value.

4. The method according to claim 1, wherein the coding parameter relates to overshooting, the method further comprises determining whether the subsequent data block will be encoded with a decreased overshoot value or not, and when it is determined that the subsequent data block will be encoded with a decreased overshoot value determining the decreased overshoot value.

5. A network coding module configured to be arranged in a network sending node for controlling encoding of data sent from the network sending node of a communication network applying Network Coding, the network coding module comprising: a processor, and a memory,
the memory storing instructions which when executed by the processor causes the network coding module to:
acquire a data block to be addressed to a network receiving node,
encode the data block in accordance with a coding parameter,
send the encoded data block addressed to a network receiving node,
receive feedback information from the network receiving node regarding decoding performance of the sent encoded data block,
based on the feedback information, determine whether the sent data block was successfully decoded by the network receiving node or not, and
when it is determined that the sent data block was not successfully decoded, determining an adjusted coding parameter value of the coding parameter, encoding the data block with the adjusted coding parameter value, and sending the with the adjusted coding parameter encoded data block addressed to the network receiving node, and
when it is determined that the sent data block was successfully decoded, encoding a subsequent data block, in accordance with the coding parameter value and sending the encoded subsequent data block addressed to the network receiving node.

6. The network coding module according to claim 5, wherein the memory comprises instructions which when executed by the processor causes the network coding module to receive the feedback information by receiving a notification that the data block was successfully decoded by the network receiving node.

7. The network coding module according to claim 5, wherein the coding parameter relates to overshooting, and wherein the memory comprises instructions which when executed by the processor causes the network coding module to determine the adjusted coding parameter value by determining an increased overshoot value.

8. The network coding module according to claim 5, wherein the coding parameter relates to overshooting, and wherein the memory comprises instructions which when executed by the processor causes the network coding module to determining whether the subsequent data block will be encoded with a decreased overshoot value or not, and when it is determined that the subsequent data block will be encoded with a decreased overshoot value determining the decreased overshoot value.

9. A network sending node comprising the network coding module according to claim 5, wherein the network sending node is implemented as a router.

10. A method performed by a network decoding module for controlling decoding of data received by a network receiving node of a communication network applying Network Coding, the method comprising:
receiving an encoded data block originating from a network sending node,
initiating decoding of the received encoded data block,
determining decoding performance of the received data block,
compiling feedback information related to the decoding performance, and
sending the feedback information to the network sending node.

11. The method according to claim 10, further comprising:
extracting a block number of the decoded block,
determining whether the extracted block number differs from a block number of a previously received block or not,
wherein compiling feedback information comprises determining whether the extracted block number differs from a block number of the previously received block or not, and wherein the compiled feedback information is further related to a determined difference between the extracted block number and the block number of the previously received block.

12. The method according to claim 10, further comprising obtaining at least one transport network parameter value from a network control node, wherein compiling feedback information is further related to the obtained at least one network parameter.

13. The method according to claim 12, wherein obtaining at least one network performance parameter value comprises determining at least one of: a link status value, a network delay value, a transport capacity value, a transport resource quality value, a packet loss value, and a congestion status value.

14. A network decoding module configured to be arranged in a network receiving node for controlling decoding of data received from the network sending node of a communication network applying Network Coding, the network decoding module comprising: a processor, and a memory,
the memory storing instructions which when executed by the processor causes the network decoding module to:
receive an encoded data block originating from a network sending node,
initiate decoding of the received encoded data block,
determine decoding performance of the received data block,
compile feedback information related to the decoding performance, and
send the feedback information to the network sending node.

15. The network decoding module according to claim 14, wherein the memory comprises instructions which when executed by the processor causes the network decoding module to:
extract a block number of the decoded block,
determine whether the extracted block number differs from a block number of a previously received block or not, and
compile the feedback information by determining whether the extracted block number differs from a block number of the previously received block or not, and base the feedback information on a determined difference between the extracted block number and the block number of the previously received block.

16. The network decoding module according to claim 14, wherein the memory comprises instructions which when executed by the processor causes the network decoding module to obtain at least one transport network parameter value from a network control nod, and compile the feedback information based on the obtained at least one network parameter.

17. The network decoding module according to claim 16, wherein the memory comprises instructions which when executed by the processor causes the network decoding module to obtain at least one network performance parameter value by determining at least one of: a link status value, a network delay value, a transport capacity value, a transport resource quality value, a packet loss value, and a congestion status value.

18. A network receiving node comprising the network decoding module corresponding according to claim 14.

19. A computer program product comprising a computer readable medium, having thereon a computer program comprising program instructions, the computer program being loadable into a data-processing unit and adapted to cause execution of the method according to claim 1 when the computer program is run by the data-processing unit.
